(19) United States
(12) Patent Application Publication
(10) Pub. No.: US 2021/0374227 A1
(43) Pub. Date: Dec. 2, 2021

(54) TRUSTED EXECUTION ENVIRONMENT (TEE)-BASED PASSWORD MANAGEMENT METHOD AND SYSTEM

(71) Applicant: Nankai University, Tianjin (CN)

(72) Inventors: Mingming CHENG, Tianjin (CN); Yuchao Gu, Tianjin (CN)

(73) Assignee: Nankai University, Tianjin (CN)

(21) Appl. No.: 17/123,208

(22) Filed: Dec. 16, 2020

(30) Foreign Application Priority Data
May 28, 2020 (CN) 202010465293.6

(51) Int. Cl. G06F 21/46; G06F 21/53; G06F 21/60; G06F 21/32; G06F 21/74; G06F 21/42

(52) U.S. Cl. CPC G06F 21/46; G06F 21/53; G06F 21/602; G06F 2221/2113; G06F 21/74; G06F 21/42; G06F 2221/2141; G06F 21/32

(57) ABSTRACT

The present disclosure discloses a trusted execution environment (TEE)-based password management method and system. This method assumes a hardware trusted environment on a mobile end. A user authorizes the hardware trusted environment, and an independent operating system in the trusted environment automatically performs password management operations. The TEE registers an independent strong password for each account, and stores a correspondence between accounts and applications (or websites) in a hardware security zone. When an application requests login, an account list corresponding to the application is returned for a user to select. Through point-to-point encrypted transmission, different trusted devices can synchronize stored password information. In addition, a trusted mobile end can manage applications (or websites) on other devices without a TEE such as laptops. This method solves the problem that users are difficult to remember a large number of complex passwords, and ensures the security of the password management system itself.

### TECHNICAL FIELD

The present disclosure relates to the field of information security, and in particular, to a trusted execution environment (TEE)—based password management method and system.

### BACKGROUND

With the popularity of smartphones, more and more affairs, such as entertainment, office, social activity, and finance, can be processed online through mobile applications or websites. For different applications or websites, users need to set passwords. Due to the increasing number of applications, it is difficult for users to remember too many complex random passwords, so they tend to set easy-to-remember passwords, which poses a threat to information security. Some users set the same password for different applications. The leaked password will cause a series of application or website password leaks, including the leak of highly sensitive financial application passwords. These habits allow hackers to crack passwords by predicting user password habits or performing credential stuffing.

One of the simplest and direct ways to solve password leaks or cracks is to set an independent random strong password for each account of each application or website, but this will greatly increase the memory difficulty for users. The password management system built by Yang Zhenlin et al. [1] can store applications and corresponding account passwords, reducing users' memory burden. Xu Ping et al. [2] use smartphones for password management and store the password information on the memory cards or SIM cards of the phones. However, the security of the password management system itself is essentially important, and a very high security mechanism is required to protect it to prevent the risk of password leaks. In the foregoing method, the password management system is built on a server or a memory card, which cannot effectively protect the password management system.

A trusted execution environment (TEE) is a unique isolated security zone in mobile devices. Many devices on the market have a TEE at the hardware security level. This zone can ensure the security, confidentiality, and integrity of the code and data inside it. The TEE provides an isolated environment that coexists with the operating system of the device. The hardware isolation technology of the TEE makes the TEE unaffected by the applications installed in the operating system of the mobile device.

This patent discloses a password management method and system based on a hardware security zone, which allow passwords to be managed by the hardware TEE. Therefore, complex strong passwords can be set for each application without requiring users to memorize them. The password management system is built based on the hardware security zone, with no need to upload passwords to a server or store passwords on external storage, reducing the risk of password leaks. Users authorize the security zone to perform all operations, which has high practicability and safety. The method and system are easy to use, and truly achieve password management and protection at the hardware security level.

[1] Yang Zhenlin, A password management method and system: China, 201210225542X, 2016 Jan. 6.

[2] Xu Ping, A method for using smart phone to implement password management: China, 2014103451281, 2018 Mar. 13.

### SUMMARY

The present disclosure provides a TEE-based password management method and system, which can implement automatic account management for a large number of applications and websites, including creating, changing, automatically filling and synchronizing passwords, and also ensure the security of the password management system itself.

To achieve the above purpose, the present disclosure provides the following technical solutions.

A TEE-based password management method includes

a) when receiving a request for entering a password from an application, sending the request to a TEE for processing;

b) creating, by the TEE, a strong password for an account of the application; and

c) storing a correspondence between the application and the account in a hardware security zone, and returning a stored account list for a user to select upon application login.

According to one aspect of the method, the method further includes: creating, by the application, a new strong password for the account in the TEE, where application-account binding information is stored in a trust zone, and registration of a plurality of new accounts and passwords is supported, that is, one application can be bound to multiple accounts.

According to another aspect of the method, when the application requests login, a plurality of bound registered accounts are retrieved in the TEE and returned, and a user selects an account for login.

According to another aspect of the method, a password operation (read, write, etc.) involving the TEE requires user authorization, comprising but not limited to fingerprint recognition, iris recognition, face recognition, and super password input; and the password operation is rejected if authentication fails.

According to another aspect of the method, in addition to managing accounts of local applications, the TEE is able to manage websites simply by taking a picture or copying the websites to a management system.

According to another aspect of the method, a trusted device (hereinafter referred to as mobile phone) is also used to manage other devices without a TEE, comprising but not limited to notebook computers, tablets (hereinafter referred to as computers); the mobile phone is connected to a computer through an encrypted point-to-point channel; a computer-end management system transmits an application ID or a URL; after TEE authorization succeeds, the mobile phone registers or retrieves a corresponding account and returns it to the computer; and the computer management system performs automatic login, wherein the trusted device is a mobile phone.

A TEE-based password management system includes:

a) a generation module, configured to receive a request for generating a password from a TEE, and randomly generate a strong password for an account, wherein the generation module is connected to a storage module;

b) the storage module, configured to receive application information and account information, and store them in a hardware security zone in pairs, wherein the storage module is connected to the generation module, an output module, and an authentication module;

c) the output module, configured to receive the application information, retrieve a corresponding account in the storage module, and return it to a requester application after authentication by the authentication module, wherein the output module is connected to the storage module;

d) the authentication module, connected to the storage module, wherein all read and write operations on the storage module need to be authenticated, and the authentication module comprises but is not limited to a fingerprint authentication module, an iris authentication module, a face recognition module, and a super password input module in a mobile phone.

According to one aspect of the system, the system further supports point-to-point interconnection between storage modules of two different trusted devices; and when both parties are authenticated by authentication modules, data in a security zone is synchronized through an encrypted point-to-point channel in device replacement, backup, or addition scenarios.

The present disclosure achieves the following technical effects: Compared with that the existing password management system needs to upload passwords to a server for storage, the present disclosure manages passwords through a hardware security zone, thereby ensuring the security of the password management system itself. This system can manage other devices, applications and websites by using a mobile phone, which saves users the trouble of memorizing passwords and reduces the risk of password leaks.

### BRIEF DESCRIPTION OF DRAWINGS

FIG. 1 is a schematic diagram of a TEE-based password management method.

FIG. 2 is a schematic diagram of a TEE-based password management system.

FIG. 3 is a schematic diagram of cross-device management.

### DETAILED DESCRIPTION

To more clearly describe the specific implementations of this system, the following describes the steps in detail with reference to the schematic diagrams.

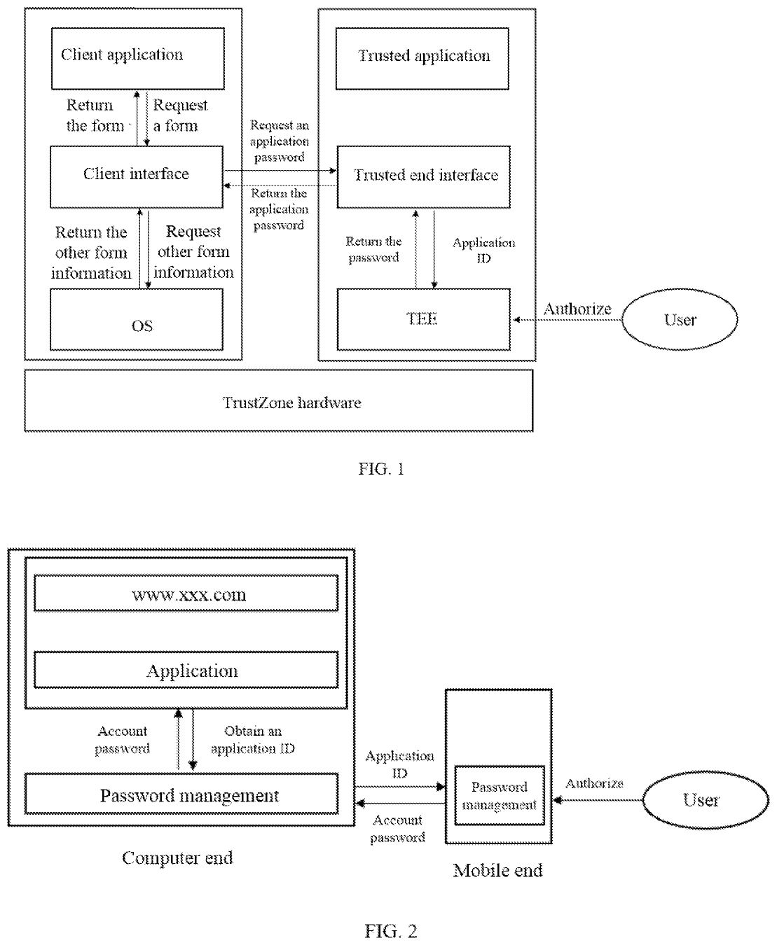

As shown in FIG. 1, a TEE-based password management method includes the following steps.

S1.An application requests to create a new account.

Specifically, the application requests a password management system to create a new account. The password management system includes a client application and a trusted-end application, which are responsible for the non-password part and the password part, respectively. The non-password part is forwarded to a normal operating system through a client interface, and is input by a user. The password part is forwarded to a TEE through a trusted end interface, and is automatically created by the TEE. The TEE is a security zone in a CPU. It runs in an independent environment and runs concurrently with the operating system. The client interface and the trusted end interface are identified by a universal unique identifier (UUID). Only two parties with the same UUID can interact with each other.

The TEE requests user authorization. The authorization methods may include but are not limited to face recognition, fingerprint recognition, and iris recognition. A fingerprint template in the TEE is compared with a fingerprint entered by a user. If the comparison fails, the operation is prohibited. If the comparison succeeds, the TEE stores an application ID and corresponding created account information in a trust zone. The trust zone is a system-level chip-level security technology, which isolates a hardware system from the security environment. The content in the trust zone cannot be directly accessed by the application. For a web end, an application ID can be entered or a photo can be taken to obtain its URL as the application ID. A plurality of accounts can be created for the same application ID.

S2. A client application requests login.

Specifically, the client requests login and sends an application ID to the TEE. The TEE requests user authorization. The authorization methods may include but are not limited to face recognition, fingerprint recognition, and iris recognition. A fingerprint template in the TEE is compared with a fingerprint entered by a user. If the comparison fails, the operation is prohibited. If the comparison succeeds, the TEE retrieves and returns accounts corresponding to the application ID. The user selects one of the accounts to log in.

S3. Perform cross-device management.

As shown in FIG. 2, a device with a TEE (known as a mobile end) such as a mobile phone implements automatic password authorization for a device without a TEE (known as a computer end) such as a laptop or a tablet computer.

Specifically, the password management client is installed on the computer end. For a computer-end application, a computer-end password management system detects its application ID. If the application is a web application, its application ID is obtained from its URL through an SHA-1 hash value. The computer-end password management system transmits the application ID to the mobile end through an encrypted point-to-point channel. After authorization, the mobile end selects a login account, and returns it to the computer-end password management system, which then controls the login.

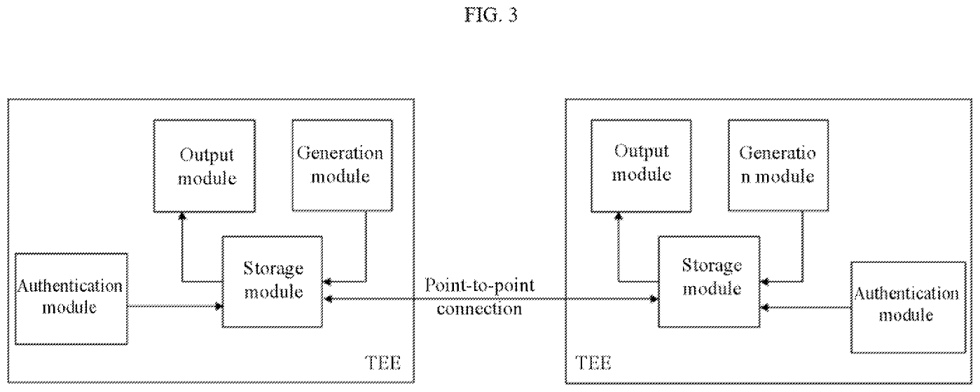

As shown in FIG. 3, a TEE-based password management system includes the following modules.

Generation module. When a request command is generate, the TEE generates a random password through the generation module. The generated password uses an application ID as a random number seed.

Storage module. When a request command is write, the storage module calls the generation module to generate a random password, and stores the password in a hardware security zone together with the application ID and an account.

Output module. When a request command is read, the output module reads a corresponding account list based on the application ID from the storage module, and returns it for a user to select an account for login.

Authentication module. When being read or written, the storage module calls the authentication module. The authentication module requests user authorization, including but not limited to fingerprint recognition, iris recognition, face recognition, and super password. After the user passes identity authentication, the authentication module authorizes the storage module to read or write the password.

The storage module can be connected through an encrypted point-to-point channel, including but not limited to Bluetooth and WLAN connection. When both parties are authenticated by the authentication module, data in a security zone can be synchronized through an encrypted point-to-point channel in scenarios such as device replacement, backup, or addition.

What is claimed is:

1. A trusted execution environment (TEE)-based password management method, comprising:
a) when receiving a request for entering a password from an application, sending the request to a TEE for processing;
b) creating, by the TEE, a strong password for an account of the application; and
c) storing a correspondence between the application and the account in a hardware security zone, and returning a stored account list for a user to select upon application login.

2. The TEE-based password management method according to claim 1, wherein the method further comprises: creating, by the application, a new strong password for the account in the TEE, wherein application-account binding information is stored in a trust zone, and registration of a plurality of new accounts and passwords is supported.

3. The TEE-based password management method according to claim 1, wherein when the application requests login, a plurality of bound registered accounts are retrieved in the TEE and returned, and a user selects an account for login.

4. The TEE-based password management method according to claim 1, wherein a password operation involving the TEE requires user authorization, comprising but not limited to fingerprint recognition, iris recognition, face recognition, and super password input; and the password operation is rejected if authentication fails.

5. The TEE-based password management method according to claim 1, wherein in addition to managing accounts of local applications, the TEE is able to manage websites simply by taking a picture or copying the websites to a management system.

6. The TEE-based password management method according to claim 1, wherein a trusted device is also used to manage other devices without a TEE, comprising but not limited to computers; the trusted device is connected to a computer through an encrypted point-to-point channel; a computer-end management system transmits an application ID or a URL; after TEE authorization succeeds, the trusted device registers or retrieves a corresponding account and returns it to the computer; and the computer management system performs automatic login, wherein the trusted device is a mobile phone.

7. A TEE-based password management system, comprising:
a) a generation module, configured to receive a request for generating a password from a TEE, and randomly generate a strong password for an account, wherein the generation module is connected to a storage module;
b) the storage module, configured to receive application information and account information, and store them in a hardware security zone in pairs, wherein the storage module is connected to the generation module, an output module, and an authentication module;
c) the output module, configured to receive the application information, retrieve a corresponding account in the storage module, and return it to a requester application after authentication by the authentication module, wherein the output module is connected to the storage module;
d) the authentication module, connected to the storage module, wherein all read and write operations on the storage module need to be authenticated, and the authentication module comprises but is not limited to a fingerprint authentication module, an iris authentication module, a face recognition module, and a super password input module in a mobile phone.

8. The TEE-based password management system according to claim 7, wherein the system further supports point-to-point interconnection between storage modules of two different trusted devices; and when both parties are authenticated by authentication modules, data in a security zone is synchronized through an encrypted point-to-point channel in device replacement, backup, or addition scenarios.
